(19) United States
(12) Patent Application Publication
(10) Pub. No.: US 2007/0256342 A1
(43) Pub. Date: Nov. 8, 2007

(54) High image resolution printed magnetic material package and method of use

(75) Inventors: Kevin L. Marquardt, Fort Scott, KS (US); Jesse D. Crum, Fort Scott, KS (US)

Correspondence Address: Michael C. Maier, Esq.;Ward Kraft, Inc., P.O. Box 938, Fort Scott, KS, 66701, US

(73) Assignee: Ward/Kraft

(21) Appl. No.: 11/416,288

(22) Filed: May 2, 2006

(51) Int. Cl. G09F 7/00

(52) U.S. Cl. 40/611.01

(57) ABSTRACT

The present invention relates to a package intended for use in small or home offices to enable preparation of personalized magnetic materials. The magnetic material is provided with at least a portion of one surface printed or a material that may be applied to a surface with one or more pre-selected fields at a resolution of greater than about 150 lines per inch. The material is supplied without a magnetic field charge such that the magnetic material may be processed through printing equipment. The package further includes a magnetizer device so that after printing the magnetic material may have a magnetic field created in the material prior to distribution to the intended recipients.

### CROSS-REFERENCES TO RELATED APPLICATIONS

None.

### FIELD OF THE INVENTION

The present invention relates to a package intended for use in small or home offices to enable preparation of personalized magnetic materials by small organizations or individuals. The magnetic material can be prepared on a large scale to obtain benefits of manufacturing efficiencies and to take advantage of available high resolution imaging technology. The package is provided with at least a portion of one surface printed or a material that may be applied to a surface with one or more pre-selected fields at a resolution of greater than about 150 lines per inch. The material is supplied without a magnetic field charge such that the magnetic material may be processed through printing equipment and potentially assembled without the difficulties of handling a magnetically charged material. The package further includes a magnetizer device so that after printing the magnetic material may have a magnetic field created in the material prior to distribution to the intended recipients.

### BACKGROUND OF THE INVENTION

There are currently a plethora of business communication constructions, marketing and advertising pieces and other items that are available in the market today for communicating products and services with an intended audience. Market segments also require different types of products and many manufacturers have attempted to produce items to meet the various demands and specifications required by end users. Yet with this inordinately large selection of offerings and permutations, there remains a continuing need to develop new products due to changes in technology, societal trends, diversification of marketing, packaging and advertising campaigns and new information handling needs of businesses and consumers alike.

Today, there are wide varieties of product offerings available that serve multiple purposes and functions, including product offerings that are used in fulfilling the needs in the small and home office or “SOHO.” Typically, such products are offered in small quantities so that certain sized organizations and individuals can utilize these offerings without having to purchase large quantities of materials. However, often these products are not produced by using the most recent technology that may be available in the marketplace thereby depriving the end user of the benefits of such technological advances.

There are also numerous magnetic products that are available in the marketplace today. Magnetic materials have become increasingly common in the business forms and labels industry for their ability to provide the customer with an advertising or remembrance piece that can be passed along or saved for future reference. Magnetic pieces have found uses in a number of applications ranging from signage to message holders to decorative pieces and memorabilia.

Today's growth of new technology and the demands of various market segments plays a vital role in creating and providing businesses with laser compatible forms and products that can be used in a variety of businesses and industries. The rise in the interest of articles having magnetic components has created a demand for the availability of such products but also has presented the manufacturer with the difficulties of including this auxiliary material along with traditional form and product stock.

In addition to the difficulties associated with having to add what amounts to a large “chunk” of material, one which typically ranges from 5 to 12 mils, onto a substrate is that the magnetic materials when placed in a stack can create a sloped stack (one side of the stack higher than the other due to the increased thickness of the magnetic material) as well as a stack that is difficult to align or handle due to the magnetic fields created by the coercive forces between poles in successive magnetic sheets. This can cause the sheets to splay or shift out of alignment making repetitive and continuous feeding difficult and often reducing such an operation to an incremental production of stops and starts so as to accomplish the production of the job.

Magnets have been previously attached to materials and used for purposes of marketing and advertising. Some exemplary prior uses of magnets include calendars, business cards, and frames for photographs, advertising collateral and the like. One example of such a prior art construction is provided in U.S. Pat. No. 5,458,282. The construction includes a solid magnet that is attached to one end of a substrate and, placed between end edges of the substrate. The magnet is then separable from the substrate via a separation line. The difficulty associated with such prior art constructions is that this construction is often limited in usage to the one advertising arrangement provided with the assembly. That is, the magnet may contain a single business card or reference or contact number and the adjoining substrate may only include printed indicia related to that one event.

Such single purpose forms aren't generally economical for use by small businesses or groups or associations as minimum quantities of such products may require the purchase of several hundred or even several thousand units, whereas a small business may only need a few dozen for selected customers, and then for those products to be potentially personalized.

In addition, to the foregoing drawback, such a construction also requires a magnetic piece to be physically juxtaposed on to a substrate in order to use the product for its intended purpose, that of enabling the substrate to be applied to a metallic surface. Due to the increased thickness of the magnetic material, the substrate along with the magnet attached thereto cannot easily pass through a laser or other non-impact printer due to the hump or bump created by the magnet. This hump can distort the printing of the substrate and potentially cause excessive wear and tear to the print head of the printer due to the abrupt contact with the raised area of the magnet. Thus, the substrate must first be printed and then have the magnetic piece attached thereto. As might be expected, this can create alignment problems if the magnetic material is applied to the incorrect area of the substrate.

Another example similar to the foregoing construction is represented by U.S. Pat. No. 5,676,307 to Martin which teaches the use of a substrate to which a magnetic strip has been adhesively applied or juxtaposed entirely over one end of the substrate, but not the entire substrate. The magnetic material is again exposed and would be subject to coercive magnetic forces if the product were placed in a stacked configuration with other similar magnetic products. That is, there is no shield or gap to prevent the magnet of one sheet from interfering with the magnet of a successive sheet. The magnetic portion of the product is then separated through the use of one or more lines of weakness.

These products suffer from several drawbacks. Initially, the line of weakness creates a jagged edge arising out of the separation of the ties from one another in the area of the line of weakness. Where the product is to be used as a remembrance item, it is highly undesirable to have an item which produces a less than desirable aesthetic feature. Secondly, a construction having such a differential height arrangement can cause problems for printing and processing equipment as discussed above. While Martin proposes the use of a ramp or beveled edge to reduce this problem, the ramp or sloped edge has been provided on one edge of the magnetic strip, the edge that is adjacent the exposed or uncovered portion of substrate of the construction. This requires the feeding of the form in only a single direction so that the processing equipment can utilize the benefit of the sloped edge.

Another prior art product is provided in UK Patent Application 2,292,474 which discloses the attachment of a ceramic magnetic disc to the back of a business card, after the business card has been prepared. This allows a user the ability to create a magnetic business card after the card has been prepared or printed. Such a product configuration however requires that the user maintain a supply of imprintable card stock, magnets and a means to attach the magnet to the card stock material. In addition, the concept utilized by the '474 application would not enable the subsequent processing of the material due to the differential thickness of the magnet on the card or stock.

More importantly however, the foregoing thus eliminates the ability for use of such products by small office/home office (“SOHO”) environments, as such environments would not have the desire to purchase rolls of magnetic material, cut the material to size and then affix the material to the substrate being printed. In addition, this prior art construction then virtually eliminates the ability to individually personalize such magnetic pieces, regardless of the size of the business.

Other prior art solutions may utilize a sheet of magnetic material which may be printed upon. However, in order to process this particular construction the magnetic material is provided in a light magnetic state or in where there is a slight magnetic field, or in one which there is no readily discernable or regular magnetic force or alternatively it is so weak that the magnetic material as provided is incapable of adhering to a metallic surface.

Solutions to the issue of splaying have been to increase the size of the material that rests between the magnetic material or to use inserts which effectively mitigate the magnetic forces between sheets by separating the sheets a sufficient amount that the coercive forces do not interact. However, in addition to the added costs of the thicker material or inserts, there is the added cost associated with transporting and shipping the material due to the increased thickness or inserts.

A still further solution to this prior art problem was to use a thinner magnetic material, one which was capable of holding only a lesser magnetic force. This construction unfortunately suffers from the drawback that the magnet may not adhere to the desired surface due to the relatively weak field.

Where it has been tried to create an image on a magnetic sheet, that retains a charge, the charge present in the sheet can cause the sheet to migrate out of alignment with the image generator or printer, thus causing the image to appear off center, blurred as the sheet is pulled away from the printing orientation or be partially cut off. This unfortunately leads to significant waste and disappointment by the producer of the magnetic product. In addition, where such sheets can be successfully printed, the sheets have a tendency to “lock up” or stick together making quick separation and distribution difficult.

In creating remembrances such as photographs and other personal memorabilia, there has been a desire to image or produce images of subjects, and to be able to personalize items in order to create magnetic elements. However, there is no convenient means by which to produce personalized magnetic materials, in small limited quantities and then be able to create a sufficient magnetic field in the material in order to use the magnet in an intended fashion.

What is needed therefore is a package of magnetic materials that can be used in SOHO type applications and which overcomes the foregoing drawbacks and renders itself to the production of cleanly removable elements that may be individually personalized and has a pleasing presentation.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one exemplary embodiment that may be practiced in accordance with the present invention a package is described which includes a supply of material. The material has a length and a width and the material further has first and second faces, with the first face having a high resolution pre-printed image on at least a portion of the first face. The second face is a magnetic material. The supply of material has a series of regularly occurring lines of weakness that are used for separating portions of magnetic material from the supply of material into individual items that can be used in creating remembrance articles. A magnetizer is also provided in the package and has a series of alternating poles for imparting a magnetic field to the second face of the supply of material.

In a further exemplary embodiment of the present invention a self-contained consumer magnetic package is provided and includes a magnetic material that has a length and width and first and second sides. The magnetic material has a printable surface that is adhesively affixed to one of the first and second sides. The printable surface has a portion that is pre-printed with indicia. The indicia is printed at a resolution of greater than about 150 lines per inch. A magnetizer has a series of repeating alternating poles with the poles spaced substantially equally apart from one another.

In a yet still further exemplary embodiment, a magnetic material package, is provided and includes a supply of magnetic material that has first and second faces, first and second transversely extending sides, first and second ends and a length and a width. A plurality of sheets of material are included in the package and the sheets have a first and second faces and a width substantially equal to the width of the supply of material.

A pre-printed image is applied to the first face, with the pre-printed image produced at a resolution of greater than about 150 lines per inch. A pressure sensitive adhesive is applied to the second face of each of the plurality of sheets. The pressure sensitive adhesive further includes a release liner covering the adhesive. The package also includes a magnetizer assembly that has a series of alternating poles which is used to affect a magnetic field charge to the magnetic material.

In addition, in connection with the foregoing embodiments, the package may include one or more business communication pieces such as pressure sensitive labels, prime labels, business forms and envelopes and the like each of which may include matching pre-printed indicia to that which is supplied on the magnetic material.

The package may also include machine readable instructions, such as computer software to assist the user in formatting the material and the substrates to achieve sufficient printing or imaging quality. The computer or machine readable instructions may also include a series or collection of images that can be used to render print onto the surface of the material or substrate.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of a magnetic intermediate having a series of removable magnetic segments with pre-printed areas on each of the segments;

FIG. 2 presents a cross sectional view of the magnetic segment intermediate produced in accordance with the present invention;

FIG. 3 shows a package of the components that may be used to create the magnetic business communication pieces; and

FIG. 4 provides a schematic of a printer having a magnetizer mounted to the imaging device.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Surprisingly, it has been found that a laminate having a magnetic base can be produced and processed without the difficulties heretofore encountered so as to create a laminated sheet that can contain a number of lines of weakness to create a number of removable or separable remembrance pieces and which can be easily processed by desktop imaging equipment. The laminate of the present invention will typically come in one of a number of formats or sizes, such as 8½″ by 11″, 11″ by 17″, 8½″ by 14″ and other sizes that can be accommodated by a desktop printing or imaging device such as may be found in a SOHO environment.

It has been discovered that there is no readily available process by which a manufacturer can create high quality, formed magnetic material having a printed substrate which has a significantly improved graphic resolution that is greater than at least about 150 lines per inch, preferably greater than about 200 lines per inch and still more preferably about 300 lines per inch, in an efficient and cost effective manner.

There are a number of terms used throughout the instant specification which are discussed below in cursory terms. The definitions provided are not intended to limit the scope of the invention and the information is provided for illustrative purposes.

As used herein the term “remembrance” item, article or element includes but is not limited to memorabilia, advertising and marketing collateral, souvenirs, tokens, trophies and certificates, keepsakes, reminders and generally other images and indicia that are intended to call to mind something about the provider of the product or the image or indicia printed or produced on the surface of the product.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturer or supplier wishes to convey to an end user or customer of the offering.

An exemplary high resolution imaging device that is used in preparing the areas of the sheets that will become the magnetic segments, in accordance with the present invention includes an Indigo®, available from Hewlett Packard of Palo Alto, Calif. A or Karat available from KBA of Williston, Vt. The present invention seeks to provide a magnetic segment or sheets useable in the preparation of a magnetic segment that has a resolution level of at least about 150 or more lines per inch and preferably more than 300 lines per inch, which is approximately equal to about 2500 to 3500 dots per inch (“DPI”) in order to create a high quality image that is intended to be aesthetically appealing to the consumer.

The magnetic material that is suitable for use in the present invention may be purchased from Strata-Tac, Inc. of Batavia, Ill. The magnetic material has a thickness ranging from about 3 to approximately 12 mils with about 5 to around 7 mils being preferred.

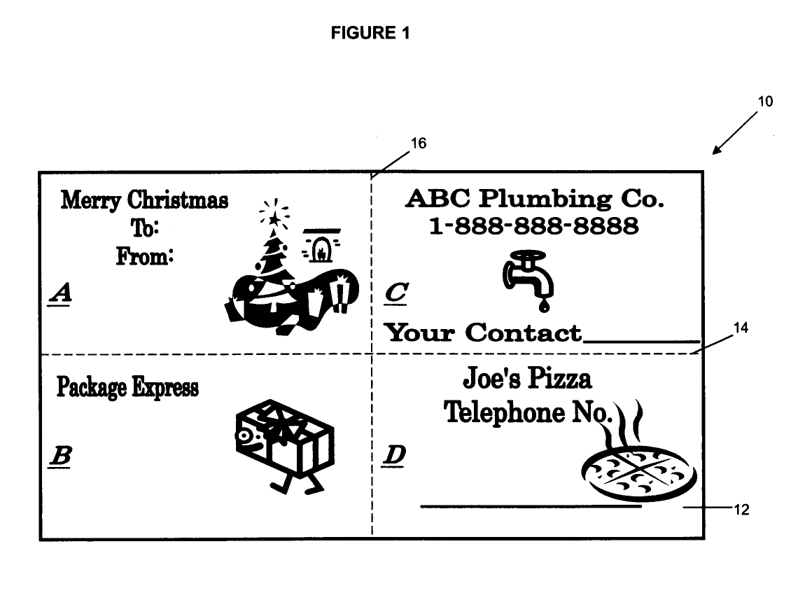

Reference is now directed to FIG. 1 of the presently described embodiment which shows a front view of a magnetic intermediate business communication produced in accordance with the present invention. The business communication intermediate is generally depicted by reference to numeral 10 and includes a first layer 12. The intermediate 10 has been divided into a number of individual magnetic segments, designated as “A”, “B”, “C” and “D”. The magnetic segments A, B, C and D are created by first and second lines of weakness 14 and 16 which extend through the first layer 12 and the magnetic material beneath the first layer 12. In the present illustration the lines of weakness 14 and 16 run substantially along the X and Y axis, respectively, that is one line is perpendicular to the other. However, it should be understood that the lines of weakness can be used to create various shapes and designs as may be requested from the end user.

Each of the magnetic segments A, B, C and D have been provided in a pre-determined format and each printed with indicia that is produced at a relatively high resolution and preferably greater than about 150 lines per inch. The indicia may include textual information that can be produced in a static or fixed format, or alternatively some level of personalization can be provided with the magnetic intermediates. Preferably, however, the personalization will be provided by the end user.

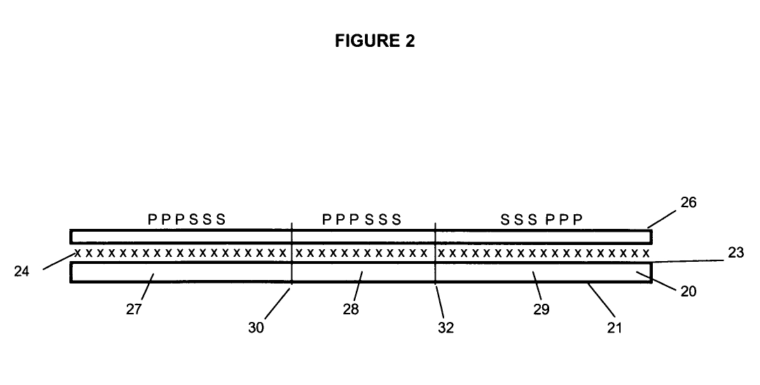

Reference is now directed to FIG. 2, which provide a cross section of the magnetic segment that is produced in accordance with the present invention. The magnetic layer 20 has first and second faces 23 and 21. A printed layer or sheet, such as a cellulosic stock or synthetic film 26, is adhered to the first layer 23 through use of an adhesive 24. The adhesive used to bond the magnetic material to the printable layer may be any suitable pressure sensitive adhesive such as an acrylic based adhesive available from National Starch of Chicago, Ill.

The sheet 26 may be printed prior to being laminated or adhered to the surface of the magnetic material, or alternatively, the sheet may be printed after it has been joined to the magnetic material. Printing or imaging on the sheet is shown by reference to “P” for personalized imaging and “S” for static or fixed imaging. Separate magnetic segments 27, 28 and 29 are created through the use of lines of weakness 30 and 32 which extend through the thickness of the material.

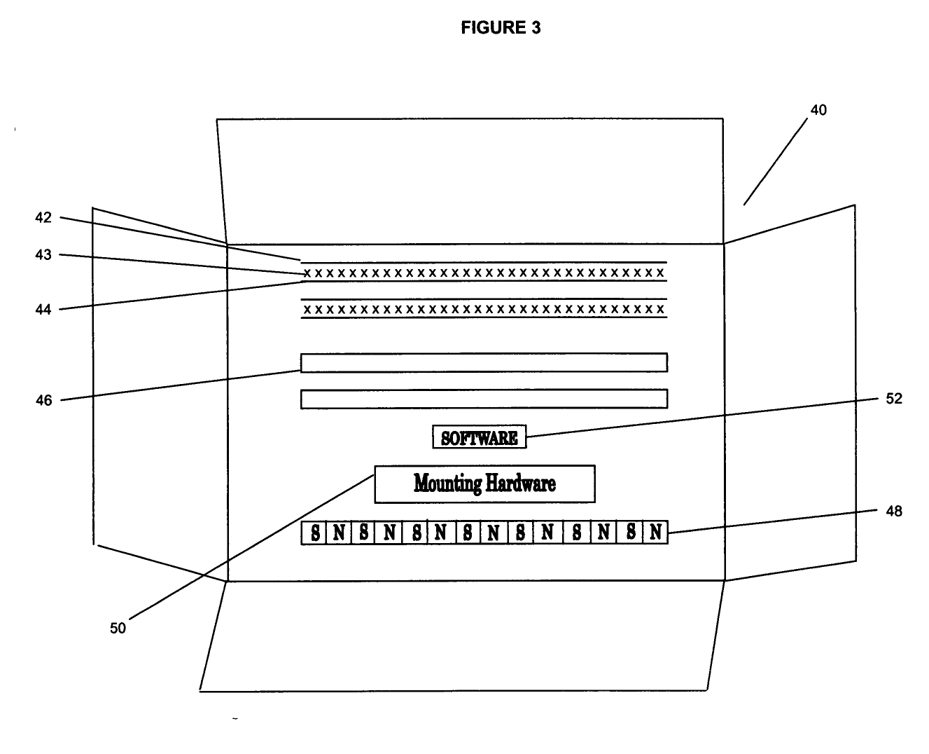

FIG. 3 provides an exemplary package that may be prepared in accordance with the presently described invention. A package, generally designated by reference numeral 40, may be any suitable shipping or delivery package. The package 40 is depicted has having a number of contents including a series or plurality of sheets, each of which includes a printable sheet 42, adhesive 43 and release liner 44. In this way, the consumer may add additional print (supplemental to the pre-printed fields already produced by high resolution imaging equipment) and then peel away the release liner and affix the printed sheet to the magnetic sheet material 46, of which the package includes a number of magnetic sheets.

The package 40 also includes a magnetizer 48 which has a number of alternating fields, which are represented by alternating “N” and “S” characters. The magnetizer 48 can be used in a manual fashion where the user applies the magnetizer to the sheets of magnetic material after printing or alternatively, the magnetizer can be affixed to the outlet end of a printer (not shown in FIG. 3) through the use of mounting hardware 50 which may also be provided in the package 40.

The package 40 may further include computer readable instructions 52, shown under the designation “software” in the package 40. The software 52 may be used for example in providing the user with formats for the addition of personalized information or other relevant instructions for the user and drivers for the printer.

The magnetic material after treatment by the magnetizer ideally will create a charge of about 12 to about 22 poles per inch with about 14 to approximately 18 poles per inch being preferred. The magnetizer is available from Ward/Kraft, Inc. of Fort Scott, Kans. and can be produced in a number of sizes and configurations depending on the particular needs of the end user. Additional mounting hardware may be supplied in connection with the magnetizer in order connect the magnetizer to the printer or imaging device such that upon exiting the printer, the magnetic material may have a magnetic field charge applied to the substrate.

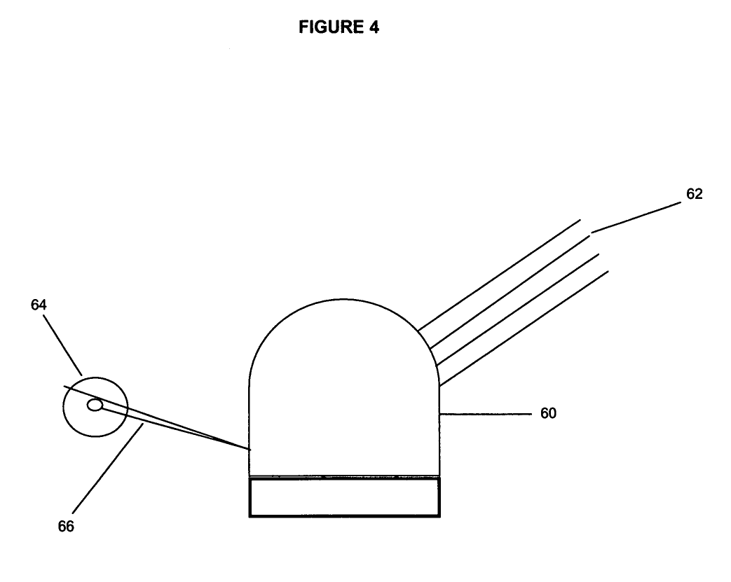

FIG. 4 provides a schematic of a printer 60 having a series of either magnetic segments or sheets for printing 62 and the magnetizer 64 affixed via hardware 66 (such as arms, fasteners and the like) to the printer 60. In this configuration, the sheets or magnetic segments pass over the magnetizer 64 and a magnetic field is created in the magnetic segments. If sheets are printed, the user can pass the magnetic material over the magnetizer in order to impart the magnetic field to the magnetic material.

It will thus be seen according to the present invention a highly advantageous consumer use package for creating personalized magnetic materials has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A package, comprising;
a supply of material, said material having a length and a width and said material further having first and second faces, with said first face having a high resolution pre-printed image on at least a portion of said first face and said second face including a magnetic material;
said supply of material having a regularly occurring lines of weakness for separating portions of said material from said supply of material to create individual magnetic segments; and
a magnetizer having a series of alternating poles for imparting a magnetic field to at least said individual magnetic segments.

2. A package as recited in claim 1, wherein said package further includes at least one pressure sensitive label having indicia matching said pre-printed image.

3. A package as recited in claim 1, wherein said package includes computer readable instructions for printing on said supply of material.

4. A package as recited in claim 3, wherein said computer readable instructions includes a collection of images.

5. A package as recited in claim 1, wherein said package includes at least one envelope for distributing said portion.

6. A package as recited in claim 1, wherein said magnetizer has a width that is substantially equivalent to said width of said supply of material.

7. A package as recited in claim 1, wherein said lines of weakness extend across said width of said supply of material.

8. A package as recited in claim 1, wherein said preprinted image is produced at a resolution of greater than about 150 lines per inch.

9. A self-contained consumer magnetic package, comprising;
a magnetic material having a length and width and first and second sides, said magnetic material having a printable surface adhesively affixed to one of said first and second sides;
said printable surface having a portion pre-printed with indicia, said indicia printed at a resolution of greater than about 150 lines per inch; and
a magnetizer having a series of repeating alternating poles with said poles spaced substantially equally apart from one another.

10. A self-contained consumer magnetic package as recited in claim 9, wherein said magnetic material is provided with a series of lines of weakness with said lines of weakness used to separate portions of said magnetic material into individual magnetic segments.

11. A self-contained consumer magnetic package as recited in claim 10, wherein said lines of weakness extend substantially perpendicularly to said length.

12. A self-contained consumer magnetic package as recited in claim 9, wherein said package includes a mounting configuration for connecting said magnetizer to a printer.

13. A self-contained consumer magnetic package as recited in claim 9, wherein said package includes pre-printed pressure sensitive labels.

14. A self-contained consumer magnetic package as recited in claim 9, wherein said indicia is printed at a resolution of greater than about 150 lines per inch.

15. A self-contained consumer magnetic package as recited in claim 9, wherein said magnetic material is provided in said package without a magnetic charge.

16. A self-contained consumer magnetic package as recited in claim 9, wherein said magnetic material is divided into geometrically shaped areas with each area having indicia related to a theme.

17. A self-contained consumer magnetic package as recited in claim 16, wherein said shaped areas are substantially quadrate.

18. A magnetic material package, comprising;
a supply of magnetic material having first and second faces, first and second transversely extending sides, first and second ends and a length and a width;
a plurality of sheets of material having a first and second faces and a width substantially equal to said width of said supply of material;
an image applied to said first face of each of said plurality of sheets of material, said image produced at a resolution of greater than about 150 lines per inch to create individual imaged sheets;
a pressure sensitive adhesive applied to said second face of each of said plurality of sheets, said pressure sensitive adhesive further including a release liner covering said adhesive, said pressure sensitive adhesive after removal of said release liner secures said individual imaged sheets to said first face of said magnetic material to create a printed magnetic segment;
said magnetic segment provided with at least one line of weakness to separate said magnetic segment into at least first and second parts; and
a magnetizer assembly having a series of alternating poles for applying a magnetic field to each of said first and second parts.

19. A magnetic material package as recited in claim 18, wherein said package include a series of pre-printed collateral material with said collateral material printed at a resolution of greater than about 150 lines per inch.

20. A magnetic material package as recited in claim 18, wherein said magnetic material is provided without a magnetic field charge.
